(19) United States
(12) Patent Application Publication
(10) Pub. No.: US 2026/0027803 A1
(43) Pub. Date: Jan. 29, 2026

(54) COMPOSITE SYSTEM

(71) Applicant: Industrial Dielectrics, Inc., Noblesville, IN (US)

(72) Inventors: Do Hyun KIM, Noblesville, IN (US); Kevin M. CAHILL, Fishers, IN (US); John DRESLINSKI, Noblesville, IN (US)

(21) Appl. No.: 19/276,757

(22) Filed: Jul. 22, 2025

Related U.S. Application Data
(60) Provisional application No. 63/674,387, filed on Jul. 23, 2024.

(51) Int. Cl. B32B 7/022; B32B 5/02; B32B 5/26; B32B 27/08; B32B 27/20

(52) U.S. Cl. CPC B32B 7/022; B32B 5/02; B32B 5/26; B32B 27/08; B32B 27/20; B32B 2250/03; B32B 2250/40; B32B 2260/021; B32B 2260/046; B32B 2307/72

(57) ABSTRACT

A composite system and methods for using and preparing a composite system including a first skin layer, a core layer, and a second skin layer is described.

### RELATED APPLICATIONS

This application claims priority under 35 U.S.C. § 119 (e) of U.S. Provisional Application No. 63/674,387, filed Jul. 23, 2024, the entire disclosure of which is incorporated herein by reference.

### BACKGROUND

The present disclosure relates to composite systems, and particularly to composite sandwich systems for use in molded components. More particularly, the present disclosure relates to composite systems including sheet molding compound including resin and fiber.

### SUMMARY

According to the present disclosure, a composite sandwich system including a first skin layer and a second skin layer, and a core layer extending between and interconnecting the first skin layer and the second skin layer is provided herein. Each of the first skin layer and the second skin layer includes a formulation and a continuous fiber. The core layer includes a formulation, a discontinuous fiber, and optionally a low-density component.

In one illustrative embodiment, the present disclosure provides a method of preparing a composite sandwich system, the method including a step of compression molding a first skin layer, a core layer, and a second skin layer. For example, the method of compression molding includes co-molding the first skin layer, core layer, and second skin layer simultaneously.

In another illustrative embodiment, a compression molding manufacturing process provides a composite system including a first skin layer, a core layer, and a second skin layer. Each of the first skin layer and the second skin layer includes a formulation and a continuous fiber. In one illustrative embodiment, the core layer includes a formulation and a discontinuous fiber. In another illustrative embodiment, the core layer includes a formulation, a discontinuous fiber, and a low-density component.

In yet another illustrative embodiment, a composite sandwich system including a first skin layer, a core layer, and a second skin layer is made in a compression molding manufacturing process. The compression molding manufacturing process provides the composite sandwich system including a first skin layer, a core layer, and a second skin layer.

In yet another illustrative embodiment, the present disclosure provides a compression-molded product including a composite sandwich system.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of an embodiment of a composite system in accordance with the present disclosure showing that the composite system 10 includes, from top to bottom, a first skin layer 2, a core layer 4, and a second skin layer 6;

FIG. 2 is a diagrammatic view of an open-configuration compression mold 40 including a top plate 42 and a bottom plate 44 configured to form an interior region 50. The interior region 50 includes a first pre-formed skin charge 12, a pre-formed core charge 14, and a second pre-formed skin charge 16. The compression mold includes a guide pin 46 and a guide bush 48;

FIG. 3 is a diagrammatic view of a closed-configuration compression mold 60. An applied pressure 58 and optional heat compresses the top plate 42 and the bottom plate 44 together, directing the guide pin into the guide bushing thereby forming a composite system in accordance with the present disclosure. The composite system 20 includes, from top to bottom, a first skin layer 22, a core layer 24, and a second skin layer 26;

FIG. 4 is a perspective view of showing a comparative two-layer composite system including a single skin layer (QISO) and SMC core layer (right) provides increased stiffness with a 20% reduction in thickness/weight compared to a single layer composite system including only SMC (left);

FIG. 5 is a graphical representation showing strength and modulus data of an SMC layer. The lamination with a second material (skin layer), such as a lightweight metallic material or a continuous fiber, may provide improved performance (higher strength and modulus) as a 3-layer sandwich structure. The improvement may be highly dependent on the used skin materials and thickness of the core material;

FIG. 6 is a diagrammatic view of a comparative honeycomb sandwich composite showing the structural advantage in the honeycomb sandwich by incorporating a core material and increasing core material thickness;

FIG. 7 is a graph of force vs. strain to measure flexural properties of four composite panels: (1) SMC only (Ex. 1A, SMC S35), (2) thin sandwich (Ex. 2B, QISO/thin core/QISO), (3) thick sandwich (Ex. 2B, QISO/thick core/QISO), and (4) low density sandwich (Ex. 3B, QISO/low density core (0.95 S.G.)/QISO); and

FIG. 8. is a diagrammatic view of a deflection test to measure stiffness of a composite panel.

### DETAILED DESCRIPTION

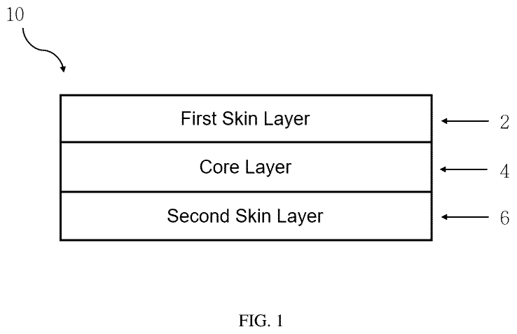

A composite system, such as a composite sandwich system, produced in accordance with the present disclosure can be formed by a co-molding manufacturing process. In one illustrative embodiment, a co-molding manufacturing process provides a composite system as shown in FIG. 1.

A composite system produced in accordance with the present disclosure includes a first skin layer 2, a core layer 4, and a second skin layer 6, which can be processed by a sheet-molding process or any other suitable process, to form a compression-molded product. A method for manufacturing a compression-molded product based on a composite system produced in accordance with the present disclosure is as described herein.

In one embodiment, the co-molding manufacturing process includes a step of adhering a first skin layer 2 to a core layer 4 and adhering a second skin layer 6 to the opposite side of the core layer 4 to form a composite system 10. In one embodiment, the layers of the composite system are arranged in a sandwich configuration including, from top to bottom, a first skin layer 2, a core layer 4, and a second skin layer 6. For example, a composite system including a first skin layer, a core layer, and a second skin layer arranged in a sandwich configuration may be referred to as a composite sandwich system.

In another embodiment, the co-molding manufacturing process includes a step of laminating a first skin layer 2 to a core layer 4 and laminating a second skin layer 6 to the opposite side of the core layer 4 to form a composite system 10. In some embodiments, the first skin layer 2, the core layer 4, and the second skin layer 6 may be adhered together by any suitable molding or laminating process as described herein, such as compression molding, transfer molding, and injection molding. In one example, the first skin layer 2, the core layer 4, and the second skin layer 6 are adhered together in a compression molding process. In some embodiments, the first skin layer 2 is adhered to the core layer 4 and the second skin layer 6 is adhered to the opposite side of the core layer 4 simultaneously. In some embodiments, the first skin layer 2, the core layer 4, and the second skin layer 6 are adhered directly using pressure, heat, or a combination, without the use of an adhesive. In some embodiments, the first skin layer 2, the core layer 4, and the second skin layer 6 can be co-molded under the same processing conditions because they include the same resin reaction kinetic components. In some embodiments, core layer 4 includes one side in direct contact, without an intervening adhesive, with the first skin layer 2, and the opposing side of the core layer 4 is in direct contact, without an intervening adhesive, with the second skin layer 6.

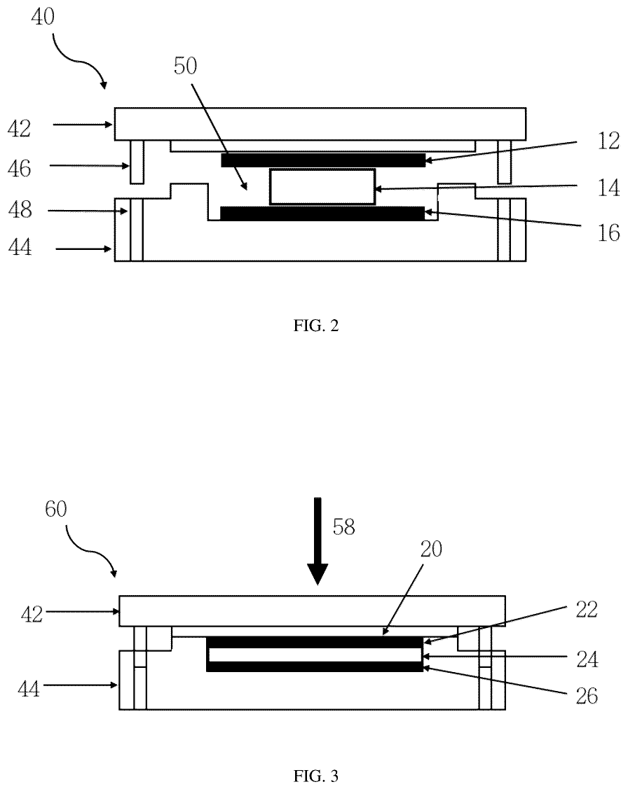

In one embodiment, the co-molding manufacturing process includes the use of a compression mold. In one embodiment, the co-molding manufacturing process includes the conversion of a compression mold in an open configuration as shown in FIG. 2 to a closed configuration compression mold as shown in FIG. 3. As shown in FIG. 2, a first pre-formed skin charge 12, a pre-formed core charge 14, and a second pre-formed skin charge 16 may be placed in an interior region 50 located between a top plate 42 and a bottom plate 44 of an open-configuration compression mold 40. An applied pressure 58 and optional heat compresses the top plate 42 and the bottom plate 44 directing the guide pin into the guide bushing as shown in FIG. 3. During the co-molding manufacturing process, the first pre-formed skin charge 12, pre-formed core charge 14, and second pre-formed skin charge 16 may flow from center to edge of the compressed interior region of the mold. In some embodiments, the first pre-formed skin charge 12 and the second pre-formed skin charge 16 are extended by about 5% (length increase to the resin flow direction) to form the first skin layer 22 and the second skin layer 26, respectively, of composite system 20. In some embodiments, the first skin layer 22 and the second skin layer 26 are arranged as outer layers around the core layer 24. In some embodiments, the pre-formed core charge 14 may have different resin flow than the first pre-formed skin charge 12 and the second pre-formed skin charge 16. In some embodiments, the pre-formed core charge 14 is extended by about 40% (length increase to the resin flow direction) to form the core layer 24. In some embodiments, the layup direction is obtained during a preliminary test of resin flow, and the first pre-formed skin charge 12, a pre-formed core charge 14, and a second pre-formed skin charge 16 are laid up to form first skin layer 22, core layer 24, and second skin layer 26 of composite system 20 in equal lengths.

In some embodiments, composite system 10 may comprise a composition. In one embodiment, composite system 10, for example, is a composite system in which a first skin layer 2, a core layer 4, and a second skin layer 6 each comprise a composition. In some embodiments, the first skin layer and the core layer are in direct contact, and the second skin layer and the core layer are in direct contact, such that no adhesive is used. In one embodiment, the first skin layer, the core layer, and the second skin layer each comprise a composition including a compatible resin. An example of a compatible resin is a resin that will adhere without the addition of an adhesive. For example, a compatible resin may be the same resin or a different resin that will adhere without the addition of an adhesive. In some embodiments, the first skin layer, the core layer, and the second skin layer each comprise the same resin. In some embodiments, the first skin layer, the core layer, and the second skin layer can be co-molded under the same processing conditions without an adhesive because each of the first skin layer, the core layer, and the second skin layer include the same resin reaction kinetic components. In some embodiments, the first skin layer, the core layer, and the second skin layer comprising the same resin and the same catalyst/curing agent comprise the same reaction rates and processing conditions. In some embodiments, there is no interface between the first skin layer, the core layer, and the second skin layer, but a continuous polymer matrix due to the ionic bonding between layers comprising the same resin chemistry.

In some illustrative embodiments, composite system 10 may include any suitable number of co-molded layers, such as 3 co-molded layers. However, any suitable number of layers may be used in composite systems of the present disclosure. Composite system 10 may include a particular configuration of co-molded layers. For example, the composite system may comprise a “sandwich” configuration in which the layers of the composite system comprise a specific ordering of layers, such that the composite system includes, from top to bottom, a first skin layer, a core layer, and a second skin layer. In some embodiments, the composite system produced in accordance with the present disclosure is a composite sandwich system comprising a sandwich configuration.

In some embodiments, the compression molding manufacturing process (e.g., co-molding) in accordance with the present disclosure may comprise a tool (i.e., mold) temperature. The tool temperature may be one of several different values or fall within one of several different ranges. In some embodiments, the tool temperature is about 150° C. The tool temperature may be one of the following values: about 120° C., about 125° C., about 130° C., about 135° C., about 140° C., about 145° C., about 150° C., about 155° C., or about 160° C. It is within the present disclosure for the tool temperature to fall within one of the following ranges: about 120° C. to about 160° C., about 120° C. to about 150° C., about 120° C. to about 140° C., about 120° C. to about 130° C., about 130° C. to about 160° C., about 130° C. to about 150° C., about 130° C. to about 140° C., about 140° C. to about 160° C., about 140° C. to about 150° C., or about 150° C. to about 160° C.

In some embodiments, the compression molding manufacturing process (e.g., co-molding) in accordance with the present disclosure may comprise a mold (i.e., in-mold) pressure. The mold pressure may be one of several different values or fall within one of several different ranges. The mold pressure may be one of the following values: about 300 psi, about 400 psi, about 500 psi, about 600 psi, about 700 psi, about 800 psi, about 900 psi, about 1000 psi, about 1100 psi, or about 1200 psi. It is within the present disclosure for the mold pressure to fall within one of the following ranges: greater than about 600 psi, greater than about 700 psi, greater than about 800 psi, greater than about 900 psi, greater than about 1000 psi, about 300 psi to about 1200 psi, about 300 psi to about 1000 psi, about 300 psi to about 800 psi, about 300 psi to about 600 psi, about 300 psi to about 500 psi, about 300 psi to about 400 psi, about 400 psi to about 1200 psi, about 400 psi to about 1000 psi, about 400 psi to about 800 psi, about 400 psi to about 600 psi, about 400 psi to about 500 psi, about 500 psi to about 1200 psi, about 500 psi to about 1000 psi, about 500 psi to about 800 psi, about 500 psi to about 700 psi, about 500 psi to about 600 psi, about 600 psi to about 1200 psi, about 600 psi to about 1000 psi, about 600 psi to about 900 psi, about 600 psi to about 800 psi, about 600 psi to about 700 psi, about 700 psi to about 1200 psi, about 700 psi to about 1000 psi, about 700 psi to about 800 psi, about 800 psi to about 1200 psi, about 800 psi to about 1000 psi, about 900 psi to about 1200 psi, about 900 psi to about 1000 psi, about 1000 psi to about 1200 psi, or about 1100 psi to about 1200 psi.

In some embodiments, the compression molding manufacturing process (e.g., co-molding) in accordance with the present disclosure may comprise a cycle time including pressing and curing time. The cycle time may be one of several different values or fall within one of several different ranges. The cycle time may be one of the following values: about 2 minutes, about 3 minutes, about 4 minutes, about 5 minutes, about 10 minutes, about 15 minutes, about 30 minutes, about 1 hour, about 1.5 hours, about 2 hours, about 3 hours, about 4 hours, or about 5 hours. It is within the present disclosure for the cycle time to fall within one of the following ranges: greater than about 2 minutes, greater than about 3 minutes, greater than about 4 minutes, greater than about 5 minutes, less than about 5 hours, less than about 2 hours, less than about 1 hour, less than about 30 minutes, less than about 10 minutes, less than about 5 minutes, about 2 minutes to about 5 hours, about 2 minutes to about 2 hours, about 2 minutes to about 1 hour, about 2 minutes to about 30 minutes, about 2 minutes to about 10 minutes, about 2 minutes to about 5 minutes, about 2 minutes to about 4 minutes, about 3 minutes to about 5 hours, about 3 minutes to about 2 hours, about 3 minutes to about 1 hour, about 3 minutes to about 30 minutes, about 3 minutes to about 10 minutes, about 3 minutes to about 5 minutes, or about 3 minutes to about 4 minutes.

In some embodiments, the composite system may comprise a density. The density of the composite system may be one of several different values or fall within one of several different ranges. The density of the composite system may be one of the following values: about 2.0 g/cm³, about 1.9 g/cm³, about 1.8 g/cm³, about 1.7 g/cm³, about 1.6 g/cm³, about 1.5 g/cm³, about 1.4 g/cm³, about 1.3 g/cm³, about 1.2 g/cm³, about 1.1 g/cm³, about 1.0 g/cm³, or about 0.9 g/cm³. It is within the present disclosure for the density of the core layer to fall within one of the following ranges: less than about 2.0 g/cm³, less than about 1.8 g/cm³, less than about 1.5 g/cm³, about 0.9 g/cm³ to about 2.0 g/cm³, about 0.9 g/cm³ to about 1.8 g/cm³, about 0.9 g/cm³ to about 1.5 g/cm³, about 0.9 g/cm³ to about 1.2 g/cm³, about 1.0 g/cm³ to about 2.0 g/cm³, about 1.0 g/cm³ to about 1.8 g/cm³, about 1.0 g/cm³ to about 1.5 g/cm³, or about 1.0 g/cm³ to about 1.2 g/cm³.

In some embodiments, the composite system may comprise a thickness. The thickness of the composite system may be one of several different values or fall within one of several different ranges. In some embodiments, the composite system may have a thickness of about 5 mm, about 5.5 mm, about 6 mm, about 6.5 mm, about 7 mm, about 7.5 mm, about 8 mm, about 8.5 mm, about 9 mm, about 9.5 mm, about 10 mm, about 10.5 mm, about 11.0 mm, about 11.5 mm, about 12.0 mm, or about 12.5 mm. It is within the present disclosure for the thickness of the composite system to fall within one of the following ranges: less than about 12.5 mm, less than about 10 mm, less than about 9 mm, less than about 8 mm, less than about 7 mm, greater than about 2 mm, greater than about 5 mm, about 2 mm to about 12.5 mm, about 2 mm to about 10 mm, about 2 mm to about 9 mm, about 2 mm to about 8 mm, about 5 mm to about 12.5 mm, about 5 mm to about 10 mm, about 5 mm to about 9 mm, or about 5 mm to about 8 mm.

In some embodiments, the composite system has a flexural strength per unit of specific gravity as calculated according to Example 4. The flexural strength per unit of specific gravity of the composite system may be one of several different values or fall within one of several different ranges. In some embodiments, the composite system may comprise a flexural strength per unit of specific gravity of about 100 MPa, about 125 MPa, about 150 MPa, about 175 MPa, about 200 MPa, about 225 MPa, or about 250 MPa. It is within the present disclosure for the flexural strength per unit of specific gravity of the composite system to fall within one of the following ranges: greater than about 100 MPa, greater than about 125 MPa, greater than about 150 MPa, about 100 MPa to about 250 MPa, about 100 MPa to about 200 MPa, about 125 MPa to about 250 MPa, about 125 MPa to about 200 MPa, about 150 MPa to about 250 MPa, or about 150 MPa to about 200 MPa.

In some embodiments, the composite system has a flexural strength as calculated according to Example 4. The flexural strength of the composite system may be one of several different values or fall within one of several different ranges. In some embodiments, the composite system may comprise a flexural strength pe of about 100 MPa, about 125 MPa, about 150 MPa, about 175 MPa, about 200 MPa, about 225 MPa, about 250 MPa, about 275 MPa, or about 300 MPa. It is within the present disclosure for the flexural strength of the composite system to fall within one of the following ranges: greater than about 100 MPa, greater than about 125 MPa, greater than about 150 MPa, greater than about 200 MPa, about 100 MPa to about 350 MPa, about 100 MPa to about 300 MPa, about 100 MPa to about 250 MPa, about 100 MPa to about 200 MPa, about 125 MPa to about 350 MPa, about 125 MPa to about 300 MPa, about 125 MPa to about 250 MPa, about 125 MPa to about 200 MPa, about 150 MPa to about 350 MPa, about 150 MPa to about 300 MPa, about 150 MPa to about 250 MPa, or about 150 MPa to about 200 MPa.

In some embodiments, the composite system has a flexural modulus per unit of specific gravity as calculated according to Example 4. The flexural modulus per unit of specific gravity of the composite system may be one of several different values or fall within one of several different ranges. In some embodiments, the composite system may comprise a flexural modulus per unit of specific gravity of about 5 GPa, about 6 GPa, about 7 GPa, about 8 GPa, about 9 GPa, about 10 GPa, about 11 GPa, about 12 GPa, about 13 GPa, about 14 GPa, or about 15 GPa. It is within the present disclosure for the flexural modulus per unit of specific gravity of the composite system to fall within one of the following ranges: greater than about 5 GPa, greater than about 8 GPa, about 5 GPa to about 15 GPa, about 6 GPa to about 15 GPa, about 8 GPa to about 15 GPa, about 5 GPa to about 12 GPa, about 6 GPa to about 12 GPa, or about 8 GPa to about 12 GPa.

In some embodiments, the composite system has a flexural modulus as calculated according to Example 4. The flexural modulus of the composite system may be one of several different values or fall within one of several different ranges. In some embodiments, the composite system may comprise a flexural modulus per unit of specific gravity of about 5 GPa, about 6 GPa, about 7 GPa, about 8 GPa, about 9 GPa, about 10 GPa, about 11 GPa, about 12 GPa, about 13 GPa, about 14 GPa, about 15 GPa, about 16 GPa, about 17 GPa, about 18 GPa, about 19 GPa, or about 20 GPa. It is within the present disclosure for the flexural modulus of the composite system to fall within one of the following ranges: greater than about 5 GPa, greater than about 8 GPa, greater than about 10 GPa, about 5 GPa to about 20 GPa, about 6 GPa to about 20 GPa, about 8 GPa to about 20 GPa, about 5 GPa to about 15 GPa, about 6 GPa to about 15 GPa, about 8 GPa to about 15 GPa, about 5 GPa to about 12 GPa, about 6 GPa to about 12 GPa, or about 8 GPa to about 12 GPa.

In some embodiments, the composite system has a deflection as calculated according to Example 4. The deflection of the composite system may be one of several different values or fall within one of several different ranges. In some embodiments, the composite system may comprise a deflection of about 5 mm, about 4 mm, about 3 mm, about 2 mm, about 1 mm, about 0.8 mm, about 0.6 mm, about 0.5 mm, about 0.4 mm, about 0.3 mm, about 0.2 mm, or about 0.1 mm. It is within the present disclosure for the deflection of the composite system to fall within one of the following ranges: less than about 5 mm, less than about 2 mm, less than about 1 mm, less than about 0.5 mm, or less than about 0.1 mm.

### Skin Layer(s).

In some embodiments, the composite system comprises two skin layers, for example, a first skin layer and a second skin layer. In some embodiments, the first skin layer and the second skin layer comprise the same composition.

In some embodiments, a skin layer (e.g., the first skin layer and/or second skin layer) of the composite system comprises, for example, a formulation and a reinforcing fiber. In one embodiment, a skin layer (e.g., the first skin layer and/or second skin layer) of the composite system comprises a formulation and a continuous fiber. In some embodiments, a skin layer (e.g., the first skin layer and/or second skin layer) comprises a formulation, a continuous fiber, and a discontinuous fiber. In some embodiments, a skin layer (e.g., the first skin layer and/or second skin layer) does not include a discontinuous fiber. In some embodiments, the formulation of a skin layer (e.g., the first skin layer and/or second skin layer) of the composite system is the same formulation as in the core layer of the composite system. In some embodiments, the formulation of a skin layer (e.g., the first skin layer and/or second skin layer) may comprise a resin. In some embodiments, the resin of a skin layer (e.g., the first skin layer and/or second skin layer) of the composite system includes the same resin of the core layer of the composite system.

In some embodiments, a skin layer (e.g., the first skin layer and/or second skin layer) of the composite system may comprise a continuous fiber that is pre-impregnated with the formulation. In some embodiments, a skin layer (e.g., the first skin layer and/or second skin layer) of the composite system may comprise a continuous fiber that is pre-impregnated with the same formulation of the core layer of the composite system. In some embodiments, a skin layer (e.g., the first skin layer and/or second skin layer) of the composite system may comprise a continuous fiber that is pre-impregnated with the same resin of the core layer of the composite system.

In some embodiments, a skin layer (e.g., the first skin layer and/or second skin layer) comprises a resin. For example, the resin may comprise a thermoset resin. Examples of plastic polymers or resins suitable for a skin layer (e.g., the first skin layer and/or second skin layer) of the composite system include a polyester resin, vinyl ester resin, epoxy resin, and the like. In some embodiments, the resin of a skin layer (e.g., the first skin layer and/or second skin layer) may comprise an unsaturated polyester resin available from INEOS Composites, AOC Resins, or Polynt Composites, Inc. In some embodiments, the resin of a skin layer (e.g., the first skin layer and/or second skin layer) may comprise a styrene monomer. In some embodiments, the resin of a skin layer comprises an unsaturated polyester resin and a styrene monomer.

The resin is not limited to unsaturated polyester resin, and 1K epoxy resin systems may be used to reduce the viscosity during the pressing time, though it may delay curing time. A recent development in the flexible epoxy SMC resin formulation (dicyandiamide (DICY)/polyamine mixture) could enable the application of the epoxy resin system in low density SMC co-molding processes.

In some embodiments, a skin layer (e.g., the first skin layer and/or second skin layer) comprises a continuous fiber. In some embodiments, the continuous fiber is a glass fiber, a carbon fiber, an aramid fiber, or a basalt fiber. In some embodiments, the continuous fiber is a glass fiber or a carbon fiber. It may be advantageous to use a particular continuous fiber in the skin layer(s) according to the particular application to increase stiffness. In some embodiments, the continuous fiber is a braided fabric.

In some embodiments, the continuous fiber is quasi-isotropic (e.g., quasi-isotropic glass fiber or quasi-isotropic carbon fiber). In some embodiments, the braided fabric comprises a quasi-isotropic braid pattern. For example, quasi-isotropic may refer to a material having isotropic properties (i.e., strength and stiffness are the same in any direction), but only in-plane. The braided fabric may have a triaxial braided fiber architecture of 0°, +/−60° and a drapable consistent fiber orientation. The bias yarns may be two over two under alternating over and under the axial yarns with equal amounts of material by weight in each direction. A braided fabric may be advantageous over plain woven or satin structure fabric in maintaining the fabric structure in the original design pattern during the compression molding process at high viscosities (even at high temperatures of 150° C.). In particular, the braided fabric may maintain its original performance after the high-pressure molding enabling high resin flow. In a comparison with plain woven fabric, composites with braided fabric showed that most physical properties of braided fabric composites were about 30% higher than those of plain woven fabric composites under the same tow size and resin system/content. In other examples, braided fabric composites showed superior toughness, superior fatigue strength, and improved impact resistance. In some examples, braided fabric composites showed reduced weight to provide the same properties.

A quasi-isotropic braided fabric may be advantageous in providing increased damage tolerance and improved energy absorption. Additionally, a quasi-isotropic braided fabric may be advantageous for its thin and light characteristics while allowing for decreased layup time. Because multiple layers of a quasi-isotropic braided fabric may have the same architecture, layering may reduce inter-laminar stresses. In some embodiments, the continuous fiber of a skin layer (e.g., the first skin layer and/or second skin layer) may comprise QISO® Fabric available from A&P Technology.

In some embodiments, the continuous fiber is anisotropic. For example, anisotropic may refer to a material with different strength and stiffness in different directions through the material. Continuous fibers that are anisotropic may have fibers all oriented in one direction, or have various degrees of anisotropy. In some embodiments, an anisotropic fabric may comprise a portion of fibers oriented in the machine direction (MD) and a portion of fibers oriented in the transverse direction (TD). For example, an anisotropic fabric may comprise 90% MD/10% TD fibers, 80% MD/20% TD fibers, or 70% MD/30% TD fibers.

In some embodiments, the formulation of a skin layer (e.g., the first skin layer and/or second skin layer) may optionally include one or more additives. Additives including, but not limited to, a curing agent (e.g., an initiator and/or a catalyst), a wetting agent, a mold release agent, a flame retarding agent, a filler, a pigment/thickener, and the like may be added to the formulations to improve the molding process and provide additional properties to the composite system. In some embodiments, the formulation of a skin layer (e.g., the first skin layer and/or second skin layer) may optionally include one or more of a curing agent (e.g., an initiator and/or a catalyst), a release agent (e.g., internal/mold release agent), a filler (e.g., a flame retarding agent), and a pigment/thickener.

In some embodiments, the formulation of a skin layer (e.g., the first skin layer and/or second skin layer) includes a resin, an initiator, a filler, and a release agent. In some embodiments, the formulation of a skin layer (e.g., the first skin layer and/or second skin layer) includes a resin, an initiator, a release agent, a flame retarding agent, a pigment/thickener, or any combination thereof.

Examples of curing agents (e.g., initiators and/or catalysts) suitable for formulations of the composite system are organic peroxides, such as methyl ethyl ketone peroxide, t-butylperoxybenzoate (TBPB), benzoyl peroxide and cumene hydroperoxide (CHP), benzyl trimethyl ammonium chloride (BTMAC) or TBPB/t-butyl peroxy octoate (TBPO), available from Nouryon Products. Examples of wetting agents suitable for formulations of the composite system are BYK W series, such as BYK-W-966, 972, 974, 996, 9010, or 9011, available from BYK Products. Examples of release agents suitable for formulations of the composite system include stearates, such as zinc stearate, calcium stearate, magnesium stearate, and lithium stearate. Examples of mold release agents suitable for formulations of the composite system include zinc stearate with a viscosity modifier, available from Norac Additives.

A filler may include flame retarding agents, pigments/thickeners, or a combination thereof. Examples of fillers suitable for formulations of the composite system include Kaolin (e.g., kaolinite, Al₂Si₂O₅(OH)₄) or calcium carbonate (CaCO₃), aluminum trihydrate, and the like. Examples of flame retarding agents suitable for formulations of the composite system include alumina trihydrate (ATH, also referred to as aluminum trihydrate), calcium carbonate, phosphorus, and the like. Examples of pigments/thickeners suitable for formulations of the composite system are powders and pastes, such as magnesium oxide (MgO), magnesium hydroxide (Mg(OH)₂), available from pigment premix companies or IDI Composites International.

In some embodiments, the formulation of a skin layer (e.g., the first skin layer and/or second skin layer) includes a ratio (e.g., PHR) of resin to an initiator. In some embodiments, the formulation of a skin layer includes a ratio of about 100:0.1 to about 100:2 of resin to initiator. For example, the formulation of a skin layer includes a ratio of about 100:1 of resin to initiator.

In some embodiments, the formulation of a skin layer (e.g., the first skin layer and/or second skin layer) includes a ratio (e.g., PHR) of resin to a release agent. In some embodiments, the formulation of a skin layer includes a ratio of about 100:1 to about 100:10 of resin to release agent. For example, the formulation of a skin layer includes a ratio of about 100:5 of resin to release agent.

In some embodiments, the formulation of a skin layer (e.g., the first skin layer and/or second skin layer) includes a ratio (e.g., PHR) of resin to a filler, such as a flame retarding agent. In some embodiments, the formulation of a skin layer includes a ratio of about 100:20 to about 100:80 of resin to filler. For example, the formulation of a skin layer includes a ratio of about 100:30 of resin to filler.

Examples of low-density components (fillers) suitable for formulations of the composite system include glass bubbles (e.g., hollow glass bubbles (HGBs)), available from 3M. For example, the glass bubbles may be K46 grade having isotactic crush strength of about 6,000 psi, K25 grade having isostatic crush strength of about 750 psi, K11 grade having isostatic crush strength of about 250 psi, or iM 16k grade having isostatic crush strength of about 16,000 psi. It may be advantageous to include hollow glass bubbles in formulations of the composite system to lower density. In some embodiments, a skin layer (e.g., the first skin layer and/or second skin layer) does not include a filler. In some embodiments, a skin layer (e.g., the first skin layer and/or second skin layer) does not include a low-density component (filler).

In some embodiments, each skin layer may comprise a volume percent (i.e., thickness) of about 5%, about 6%, about 7%, about 8%, about 9%, about 10%, about 11%, about 12%, about 13%, about 14%, or about 15% of the composite system. It is within the present disclosure for each skin layer volume percent of the composite system to fall within one of the following ranges: greater than about 5%, less than about 15%, about 5% to about 15%, about 5% to about 12%, about 5% to about 10%, about 8% to about 15%, about 8% to about 12%, or about 8% to about 10% of the composite system. In some embodiments, the first skin layer and the second skin layer have the same thickness volume percent (i.e., thickness) of the composite system.

In some embodiments, each skin layer may comprise a thickness. The thickness of each skin layer may be one of several different values or fall within one of several different ranges. In some embodiments, each skin layer may comprise a thickness of about 0.1 mm, 0.2 mm, about 0.3 mm, about 0.4 mm, about 0.5 mm, about 0.6 mm, about 0.7 mm, about 0.8 mm, about 0.9 mm, or about 1.0 mm. It is within the present disclosure for the thickness of each skin layer to fall within one of the following ranges: less than about 1.0 mm, less than about 0.9 mm, about 0.1 mm to about 1.0 mm, about 0.1 mm to about 0.8 mm, about 0.2 mm to about 1.0 mm, about 0.2 mm to about 0.8 mm, about 0.4 mm to about 1.0 mm, about 0.4 mm to about 0.8 mm, about 0.6 mm to about 1.0 mm, or about 0.6 mm to about 0.8 mm. In some embodiments, the first skin layer and the second skin layer have the same thickness.

### Core Layer.

In some embodiments, the core layer of the composite system comprises a sheet molding compound or composite (SMC). In some embodiments, the core layer of the composite system may be referred to as an SMC layer or an SMC core layer. In one example, the sheet molding compound (SMC) is a ready to mold glass-fiber reinforced polymer material primarily used in compression molding.

In some embodiments, a core layer of the composite system comprises, for example, a formulation and a reinforcing fiber. In one embodiment, a core layer of the composite system comprises a formulation and a discontinuous fiber. In some embodiments, the formulation of a core layer of the composite system is the same formulation as in the skin layer(s) (e.g., the first skin layer and/or second skin layer) of the composite system. In some embodiments, the formulation of a core layer may comprise a resin. In some embodiments, the resin of a core layer of the composite system includes the same resin of the skin layer(s) (e.g., the first skin layer and/or second skin layer) of the composite system.

In some embodiments, the discontinuous fiber, the formulation, and the low-density component, when present, of the core layer are distributed (e.g., uniformly distributed) throughout the core layer.

In some embodiments, a core layer of the composite system may comprise a discontinuous fiber that is pre-impregnated with the formulation. In some embodiments, a core layer of the composite system may comprise a discontinuous fiber that is pre-impregnated with the same formulation of the skin layer(s) (e.g., the first skin layer and/or second skin layer) of the composite system. In some embodiments, a core layer of the composite system may comprise a discontinuous fiber that is pre-impregnated with the same resin of the skin layer(s) (e.g., the first skin layer and/or second skin layer) of the composite system.

In some embodiments, the core layer of the composite system may comprise a weight percentage of discontinuous fiber. The weight percent of discontinuous fiber in the core layer may be one of several different percentages or fall within one of several different ranges. In some embodiments, the core layer may comprise a weight percent of discontinuous fiber of about 10 wt %, about 15 wt %, about 20 wt %, about 25 wt %, about 30 wt %, about 35 wt %, or about 40 wt % of the core layer. It is within the present disclosure for the weight percent of discontinuous fiber of the core layer to fall within one of the following ranges: greater than about 10 wt %, greater than about 15 wt %, less than about 40 wt %, less than about 35 wt %, about 10 wt % to about 40 wt %, about 10 wt % to about 35 wt %, about 10 wt % to about 30 wt %, about 10 wt % to about 25 wt %, about 10 wt % to about 20 wt %, about 15 wt % to about 40 wt %, about 15 wt % to about 35 wt %, about 15 wt % to about 30 wt %, about 15 wt % to about 25 wt %, about 20 wt % to about 40 wt %, about 20 wt % to about 35 wt %, about 20 wt % to about 30 wt %, about 25 wt % to about 40 wt %, about 25 wt % to about 35 wt %, or about 30 wt % to about 40 wt %.

In some embodiments, a core layer comprises a resin. For example, the resin may comprise a thermoset resin. Examples of plastic polymers or resins suitable for a core layer of the composite system include a polyester resin, vinyl ester resin, epoxy resin, and the like. In some embodiments, the resin of a core may comprise an unsaturated polyester resin available from INEOS Composites, AOC Resins, or Polynt Composites, Inc. In some embodiments, the resin of a core layer may comprise a styrene monomer. In some embodiments, the resin of a core layer comprises an unsaturated polyester resin and a styrene monomer.

The resin is not limited to unsaturated polyester resin, and 1K epoxy resin systems may be used to reduce the viscosity during the pressing time, though it may delay curing time. A recent development in the flexible epoxy SMC resin formulation (dicyandiamide (DICY)/polyamine mixture) could enable the application of the epoxy resin system in low density SMC co-molding processes.

In some embodiments, a core layer comprises a discontinuous fiber (e.g., chopped fiber). In some embodiments, the discontinuous fiber comprises long strands (e.g., greater than about 0.5″ or about 1″) of chopped fiber. The longer fibers in the core layer may result in better strength properties than comparative bulk molding compound (BMC) products.

In some embodiments, the discontinuous fiber is a glass fiber, a carbon fiber, an aramid fiber, or a basalt fiber. In some embodiments, the discontinuous fiber is a glass fiber or a carbon fiber. Examples of suitable glass fiber, include but are not limited to, AES glass, E glass, ECR glass, silica glass, S glass, R glass, M glass, C glass, D glass, AR glass, T glass, Q glass, and the like. In some embodiments, the fiber includes a discontinuous fiber, a continuous fiber, or combination thereof. A discontinuous fiber includes, but is not limited to, of chopped fiber, commonly glass fibers or carbon fibers. In some embodiments, the discontinuous fiber of the core layer may comprise E glass (e.g., about 25 mm chopped E glass). In some embodiments, the discontinuous fiber is a glass fiber, available from Owens Corning Company.

In some embodiments, the formulation of a core layer may optionally include one or more additives. Additives including, but not limited to, a curing agent (e.g., an initiator and/or a catalyst), a wetting agent, a mold release agent, a flame retarding agent, a filler (e.g., a low-density component), a pigment/thickener, and the like may be added to the formulations to improve the molding process and provide additional properties to the composite system. In some embodiments, the formulation of a core layer may optionally include one or more of a curing agent (e.g., an initiator and/or a catalyst), a release agent (e.g., internal/mold release agent), a filler (e.g., a flame retarding agent), and a pigment/thickener.

In some embodiments, the formulation of a core layer includes a resin, an initiator, a filler, and a release agent. In some embodiments, the formulation of a core layer includes a resin, an initiator, a release agent, a flame retarding agent, a pigment/thickener, or any combination thereof.

Examples of curing agents (e.g., initiators and/or catalysts) suitable for formulations of the composite system are organic peroxides, such as methyl ethyl ketone peroxide, t-butylperoxybenzoate (TBPB), benzoyl peroxide and cumene hydroperoxide (CHP), benzyl trimethyl ammonium chloride (BTMAC) or TBPB/t-butyl peroxy octoate (TBPO), available from Nouryon Products. Examples of wetting agents suitable for formulations of the composite system are BYK W series, such as BYK-W-966, 972, 974, 996, 9010, or 9011, available from BYK Products. Examples of release agents suitable for formulations of the composite system include stearates, such as zinc stearate, calcium stearate, magnesium stearate, and lithium stearate. Examples of mold release agents suitable for formulations of the composite system include zinc stearate with a viscosity modifier, available from Norac Additives.

A filler may include flame retarding agents, pigments/thickeners, or a combination thereof. Examples of fillers suitable for formulations of the composite system include Kaolin (e.g., kaolinite, Al₂Si₂O₅(OH)₄) or calcium carbonate (CaCO₃), aluminum trihydrate, and the like. Examples of flame retarding agents suitable for formulations of the composite system include alumina trihydrate (ATH, also referred to as aluminum trihydrate), calcium carbonate, phosphorus, and the like. Examples of pigments/thickeners suitable for formulations of the composite system are powders and pastes, such as magnesium oxide (MgO), magnesium hydroxide (Mg(OH)₂), available from pigment premix companies or IDI Composites International.

In some embodiments, the formulation of a core layer includes a ratio (e.g., PHR) of resin to an initiator. In some embodiments, the formulation of a core layer includes a ratio of about 100:0.1 to about 100:2 of resin to initiator. For example, the formulation of a core layer includes a ratio of about 100:1 of resin to initiator.

In some embodiments, the formulation of a core layer includes a ratio (e.g., PHR) of resin to a release agent. In some embodiments, the formulation of a core layer includes a ratio of about 100:1 to about 100:10 of resin to release agent. For example, the formulation of a core layer includes a ratio of about 100:5 of resin to release agent.

In some embodiments, the formulation of a core layer includes a ratio (e.g., PHR) of resin to a filler, such as a flame retarding agent. In some embodiments, the formulation of a core layer includes a ratio of about 100:20 to about 100:80 of resin to filler. For example, the formulation of a core layer includes a ratio of about 100:30, about 100:31, about 100:32, about 100:33, about 100:34, or about 100:35 of resin to filler.

Examples of low-density components (fillers) suitable for formulations of the composite system include glass bubbles (e.g., hollow glass bubbles (HGBs)), available from 3M, Omya, or other manufacturers. The low-density component may be one of several grades having various densities and crush strengths. For example, the glass bubbles may be K46 grade having isotactic crush strength of about 6,000 psi, K25 grade having isostatic crush strength of about 750 psi, K11 grade having isostatic crush strength of about 250 psi, or iM 16k grade having isostatic crush strength of about 16,000 psi. It may be advantageous to include hollow glass bubbles in formulations of the composite system to lower density. Additional examples of low-density components (fillers) suitable for formulations of the composite system include (organic or inorganic) microspheres and expandable polymeric microspheres, available from Nouryon. In some embodiments, low-density component (filler) is selected from the group consisting of glass bubbles, organic microspheres, inorganic microspheres, expandable polymer microspheres, and any combination thereof.

In some embodiments, the formulation of a core layer includes a ratio (e.g., PHR) of resin to a low-density component. In some embodiments, the formulation of a core layer includes a ratio of about 100:20 to about 100:80 of resin to low-density component.

In some embodiments, co-molding process conditions may be dependent on the composition of the core layer, particularly on a low-density component, such as glass bubbles (HGBs) and their associated crush strengths. It may be understood that a component having a lower density may also have lower crush strength. It may be advantageous to use high crush strength components with relatively high density (e.g., about 0.46) to endure high pressure molding processes. Alternatively, in lower density applications, a component with a lower crush strength and density may be used to provide a corresponding low-density composite. In some embodiments, the molding process conditions can be modified (e.g., cycle time increased) to provide a low-density composite to minimize damage to the low-density component. For example, it may take a longer time to preheat and compress low-density core layers including low isostatic crush strength HGBs compared to a core layer without HGBs.

In some embodiments, the low-density component may comprise a crush strength. The crush strength of the low-density component may be one of several different values or fall within one of several different ranges. It is within the present disclosure for the crush strength of the low-density component to fall within one of the following ranges: less than about 50,000 psi, less than about 30,000 psi, less than about 10,000 psi, less than about 1,000 psi, less than about 500 psi, greater than about 100 psi, greater than about 250 psi, greater than about 500 psi, greater than about 1,000 psi, greater than about 10,000 psi, about 100 psi to about 50,000 psi, about 100 psi to about 30,000 psi, about 100 psi to about 10,000 psi, about 100 psi to about 1,000 psi, about 250 psi to about 50,000 psi, about 250 psi to about 30,000 psi, about 250 psi to about 10,000 psi, about 250 psi to about 1,000 psi, about 500 psi to about 50,000 psi, about 500 psi to about 30,000 psi, about 500 psi to about 10,000 psi, or about 500 psi to about 1,000 psi.

In some embodiments, the low-density component may comprise a density. The density of the low-density component may be one of several different values or fall within one of several different ranges. The density of the low-density component may be one of the following values: about 0.9 g/cm³, about 0.8 g/cm³, about 0.7 g/cm³, about 0.6 g/cm³, about 0.5 g/cm³, about 0.4 g/cm³, about 0.3 g/cm³, about 0.2 g/cm³, or about 0.1 g/cm³. It is within the present disclosure for the density of the low-density component to fall within one of the following ranges: less than about 1.0 g/cm³, less than about 0.8 g/cm³, less than about 0.7 g/cm³, less than about 0.6 g/cm³, less than about 0.5 g/cm³, less than about 0.4 g/cm³, less than about 0.3 g/cm³, less than about 0.2 g/cm³, about 0.1 g/cm³ to about 1.0 g/cm³, about 0.1 g/cm³ to about 0.8 g/cm³, about 0.1 g/cm³ to about 0.6 g/cm³, or about 0.1 g/cm³ to about 0.4 g/cm³.

In some embodiments, the core layer of the composite system may comprise a weight percentage of the low-density component. The weight percent of low-density component in the core layer may be one of several different percentages or fall within one of several different ranges. In some embodiments, the core layer may comprise a weight percent of low-density component of about 10 wt %, about 15 wt %, about 20 wt %, about 25 wt %, about 30 wt %, about 35 wt %, about 40 wt %, about 45 wt %, about 50 wt %, about 55 wt %, or about 60 wt % of the core layer. It is within the present disclosure for the weight percent of low-density component of the core layer to fall within one of the following ranges: greater than about 10 wt %, greater than about 15 wt %, greater than about 20 wt %, less than about 60 wt %, less than about 50 wt %, about 10 wt % to about 60 wt %, about 10 wt % to about 50 wt %, about 10 wt % to about 40 wt %, about 10 wt % to about 35 wt %, about 10 wt % to about 30 wt %, about 15 wt % to about 60 wt %, about 15 wt % to about 50 wt %, about 15 wt % to about 40 wt %, about 15 wt % to about 35 wt %, about 15 wt % to about 30 wt %, about 20 wt % to about 60 wt %, about 20 wt % to about 50 wt %, about 20 wt % to about 40 wt %, about 20 wt % to about 35 wt %, or about 20 wt % to about 30 wt %.

In some embodiments, density (p) of a layer or composite can be calculated using the weight fraction and density of each component. Density (p) may be measured as a mass per volume or as a specific gravity. Specific gravity may be referred to as a value of the density of a component divided by the density of water (about 1 g/cm³ at STP). In some embodiments, the density of a component is the same as the specific gravity of the component. The terms density and specific gravity may be used interchangeably.

In some embodiments, the core layer of the composite system may comprise a density. The density of the core layer may be one of several different values or fall within one of several different ranges. In some embodiments, the core layer comprises a density of about 1.5 g/cm³, about 1.4 g/cm³, about 1.3 g/cm³, about 1.2 g/cm³, about 1.1 g/cm³, about 1.0 g/cm³, about 0.9 g/cm³, about 0.6 g/cm³, or about 0.3 g/cm³. The density of the core layer may be one of the following values: about 1.0 g/cm³, about 0.9 g/cm³, about 0.8 g/cm³, about 0.7 g/cm³, about 0.6 g/cm³, about 0.5 g/cm³, about 0.4 g/cm³, about 0.3 g/cm³, or about 0.2 g/cm³. It is within the present disclosure for the density of the core layer to fall within one of the following ranges: less than about 1.5 g/cm³, less than about 1.4 g/cm³, less than about 1.3 g/cm³, less than about 1.2 g/cm³, less than about 1.1 g/cm³, less than about 1.0 g/cm³, less than about 0.8 g/cm³, less than about 0.7 g/cm³, less than about 0.6 g/cm³, less than about 0.5 g/cm³, less than about 0.4 g/cm³, less than about 0.3 g/cm³, about 0.2 g/cm³ to about 1.5 g/cm³, about 0.2 g/cm³ to about 1.4 g/cm³, about 0.2 g/cm³ to about 1.3 g/cm³, about 0.2 g/cm³ to about 1.2 g/cm³, about 0.2 g/cm³ to about 1.1 g/cm³, about 0.2 g/cm³ to about 1.0 g/cm³, about 0.2 g/cm³ to about 0.9 g/cm³, about 0.2 g/cm³ to about 0.8 g/cm³, about 0.2 g/cm³ to about 0.7 g/cm³, about 0.2 g/cm³ to about 0.6 g/cm³, about 0.2 g/cm³ to about 0.5 g/cm³, and about 0.2 g/cm³ to about 0.4 g/cm³.

In some embodiments, the core layer may comprise a total weight percent (i.e., thickness) of the composite system. The core layer weight percent of the composite system may be one of several different values or fall within one of several different ranges. In some embodiments, the core layer may comprise a weight percent of about 5 wt %, about 10 wt %, about 15 wt %, about 20 wt %, about 25 wt %, about 30 wt %, about 35 wt %, about 40 wt %, about 45 wt %, or about 50 wt % of the composite system. It is within the present disclosure for the core layer weight percent of the composite system to fall within one of the following ranges: greater than about 5 wt %, greater than about 10 wt %, greater than about 15 wt %, less than about 50 wt %, less than about 45 wt %, less than about 40 wt %, about 5 wt % to about 50 wt %, about 5 wt % to about 45 wt %, about 5 wt % to about 40 wt %, about 5 wt % to about 35 wt %, about 5 wt % to about 30 wt %, about 5 wt % to about 25 wt %, about 5 wt % to about 20 wt %, about 10 wt % to about 50 wt %, about 10 wt % to about 40 wt %, about 10 wt % to about 30 wt %, about 10 wt % to about 20 wt %, about 15 wt % to about 50 wt %, about 20 wt % to about 50 wt %, about 20 wt % to about 40 wt %, about 20 wt % to about 30 wt %, about 25 wt % to about 50 wt %, about 30 wt % to about 50 wt %, about 30 wt % to about 40 wt %, about 35 wt % to about 50 wt %, about 40 wt % to about 50 wt %, about 45 wt % to about 50 wt %, or about 20 wt % to about 30 wt % of the composite system.

In some embodiments, the core layer may comprise a volume percent (i.e., thickness) of about 55%, about 60%, about 65%, about 70%, about 75%, about 80%, about 85%, about 90%, or about 95% of the composite system. It is within the present disclosure for the core layer volume percent of the composite system to fall within one of the following ranges: greater than about 55%, greater than about 60%, greater than about 65%, greater than about 70%, greater than about 75%, greater than about 80%, greater than about 85%, less than about 95%, less than about 90%, about 60% to about 95%, about 60% to about 90%, about 60% to about 85%, about 70% to about 95%, about 70% to about 90%, about 70% to about 85%, about 80% to about 95%, about 80% to about 90%, or about 80% to about 85% of the composite system.

In some embodiments, the core layer may comprise a thickness. The thickness of the core layer may be one of several different values or fall within one of several different ranges. In some embodiments, the core layer may comprise a thickness of about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm. It is within the present disclosure for the thickness of the core layer to fall within one of the following ranges: less than about 10 mm, less than about 9 mm, less than about 8 mm, less than about 7 mm, greater than about 5 mm, greater than about 5 mm, about 4 mm to about 10 mm, about 4 mm to about 9 mm, about 4 mm to about 8 mm, about 4 mm to about 7 mm, about 4 mm to about 6 mm, about 5 mm to about 9 mm, about 5 mm to about 8 mm, about 5 mm to about 7 mm, or about 5 mm to about 6 mm.

The present disclosure relates to composite systems for use in lightweight mobility parts (i.e., a component in a vehicle) including parts for an aircraft, a train, or an automobile. Additional applications include, but are not limited to, electrical applications, corrosion resistant products, structural components, automotive parts, and other mobility parts. Examples of mobility parts include, but are not limited to, interior floor panels, interior wall panels, truck beds, battery enclosures, and the like. Examples of vehicles include, but are not limited to, an urban air mobility (UAM), an unmanned aerial vehicle (UAV), a high speed train, or an automobile. It may be advantageous for mobility parts to be lightweight to enable saving in fuel and carbon footprint.

The composite system according to exemplary embodiments of the present disclosure satisfies a long-felt need for a composite system that includes the features of structural strength and stiffness, lightweight (i.e., medium or low density), and low cost. Others have failed to provide a composite system that achieves combinations of these features as reflected in the appended claims. This failure is a result of the many features being associated with competitive design choices. As an example, others have created composite systems that based on design choices possess strength and stiffness and but fail to provide comparable lightweight and economical cost. In comparison, the composite system of the present disclosure overcomes the challenges and failures of others by including a low density core layer and two skin layers in a co-molding process to balance the properties of structural strength and stiffness and weight while maintaining a low cost.

The composite system according to exemplary embodiments of the present disclosure satisfies a long-felt need for a composite system that includes improved bonding strength (interlaminar shear strength) between skin layers and core layer at a low-cost. The co-molding process to exemplary embodiments of the present disclosure could improve the bonding strength between core layer and skin layer(s), because they comprise the same resin material and reaction kinetics. In comparative examples, most defects of the sandwich structure includes the delamination between core layer and skin layer(s), which could lead the breakage of the panel.

The performance of composite systems may be controlled by including or modifying the composition of reinforcing fibers, low-density components, low profile agents, colorants, anti-flame agents, and the other additives. For example, properties such as low density, high strength, low shrinkage, dimensional stability, paintable, UV stability/colorfast, low flame/smoke toxicity, corrosion resistance, and dielectric/flame resistance, may be balanced as shown in FIG. 5. For example, hybrid composites including an SMC layer in combination with a lightweight metallic material or a continuous fiber layer may provide for enhanced performance (higher strength and modulus).

The composite system according to exemplary embodiments of the present disclosure, including a first skin layer, a core layer, and a second skin layer in a sandwich configuration may provide a structural advantage of an elevated stiffness over comparative two layer composites including a single skin layer and SMC core layer.

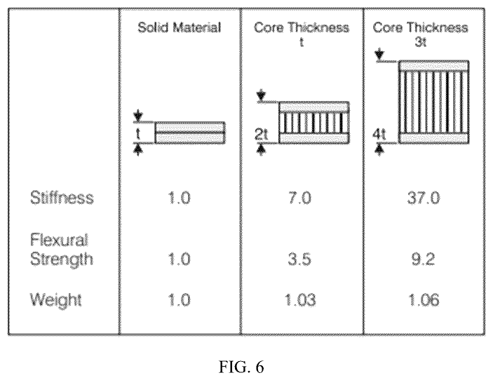

Currently, there is a need for lightweight and stiff composites as a low-cost alternative to a comparative honeycomb composite example. In one example, a low-density core sandwich structure according to a honeycomb composite, the stiffness of the composite is increased almost 40 times with just a 25% weight increase, if the low-density core layer increased thickness by 4 times, as shown in FIG. 6. However, the honeycomb core material is expensive, and its application requires the additional high cost of machining processing and bonding with skins. The honeycomb core is processed by many serial unit processes such as coating, cutting and slitting, layup, bonding, expanding, dipping into the thermoset resin, oven curing, cutting/machining. Composite systems in accordance with the present disclosure may provide solutions to the need described herein.

The composite system according to exemplary embodiments of the present disclosure, could provide an advantage over the comparative honeycomb composite by forming a sandwich composite in an economical co-molding process. For example, the total cost might be less than about one third with a medium density core layer of about 0.5 g/cm³.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value.

### Examples

The following examples and representative procedures illustrate features in accordance with the present disclosure, and are provided solely by way of illustration. They are not intended to limit the scope of the appended claims or their equivalents. Parts and percentages appearing in such examples are by volume, or thickness, unless otherwise stipulated. For example, components in some examples may appear as parts per hundred parts of resin (phr), or as weight fraction per total weight (wf). All ASTM, ISO, UL and other standard test methods cited or referred to in this disclosure are incorporated by reference in their entirety.

### Example 1A. Comparative Single Layer SMC Molding

A comparative one-layer composite system is provided in the instant example. The one-layer SMC composite system was provided using the following molding conditions:
Tool temp: 150° C.
In-mold pressure>1000 psi
Vacuum: 635 mmHg (90 sec)
Cycle time>3 min

The SMC of the instant example can be used to make traditional composites products like electrical applications (various cases, switch gears, insulation parts, etc.), automotive and transportation applications (body panels, pick up boxes, EV battery enclosure, train units, etc.), construction applications (door skins, fencing, roofing, window panels, etc.), and others.

A representative composition of the composite system of the instant example having a density of about 1.65 g/cm³ is provided in Table 1A. The resin mixture included an unsaturated polyester (UP) with styrene monomer.

TABLE 1A
SMC only (density~1.65)

| | PHR | wf | ρ | wf/ρ |
|---|---|---|---|---|
| UP resin mixture | 100 | 0.365 | 1.1 | 0.332 |
| Initiator | 1 | 0.004 | 1 | 0.004 |
| internal release agent | 5 | 0.018 | 1.1 | 0.017 |
| filler | 27 | 0.099 | 2.4 | 0.041 |
| pigment thickener | 6 | 0.022 | 1.5 | 0.015 |
| chopped glass roving | 135 | 0.493 | 2.6 | 0.190 |
| sum | 274 | 1.000 | Average | 1.675 |
| | | | density | |

### Example 1B. Preliminary Process Trial

A comparative two-layer composite system is provided in the instant example. An unsaturated polyester (UP) resin is used in both layers. As an initial process trial, a composite including a single skin layer comprising glass fiber QISO, and a single core SMC layer was provided by co-molding (compression molding) the layers using the following molding conditions, as in Example 1A:
Tool temp: 150° C.
In-mold pressure>1000 psi
Vacuum: 635 mmHg (90 sec)
Cycle time>3 min

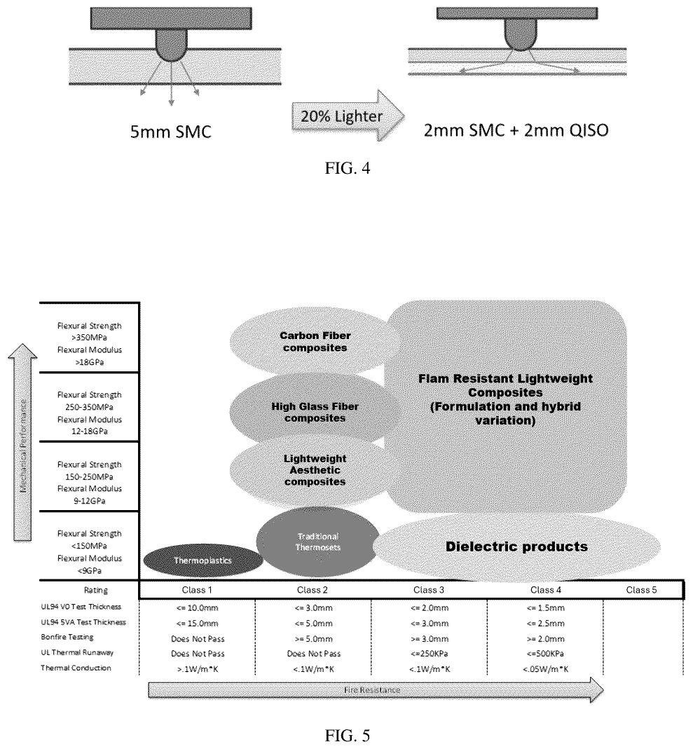

From this QISO/SMC molding process, it was found that each layer showed a different extension by resin flow during the co-molding process. For a flat shape skateboard mold, the SMC core layer showed a 40% length increase in the resin flow direction and the skin layer showed a 5% length increase. Under the same molding conditions in this QISO/SMC molding test, a thickness/weight reduction was observed as compared to a single SMC layer, as shown in FIG. 4.

### Example 2A. Medium Density Composite Formulation

An exemplary composite system in accordance with certain aspects of the present disclosure is provided in the instant example. Such composites may be used in automotive panels, RV panels, and/or e-mobility. A composite system with a first skin layer and a second skin layer comprising glass fiber QISO prepreg, and a core layer with a density of 1.03 g/cm³ (about 1 g/cm³) is provided in Table 2A. An unsaturated polyester (UP) resin is used in each layer.

TABLE 2A
QISO/SMC(density~1)/QISO.

| | Core density ~1.0 | | | | | | | |
|---|---|---|---|---|---|---|---|---|
| | Core Layer | | | | Skin Layer (QISO prepreg) | | | |
| Formulation | PHR | wf | ρ | wf/ρ | PHR | wf | ρ | wf/ρ |
| UP Resin mixture | 100 | 0.35 | 1.3 | 0.27 | 100 | 0.76 | 1.3 | 0.58 |
| Wetting Agent | 0.4 | 0.00 | 1 | 0.00 | 0.4 | 0.00 | 1 | 0.00 |
| Initiator | 0.4 | 0.00 | 1 | 0.00 | 0.4 | 0.00 | 1 | 0.00 |
| Fine Zinc stearate | 5 | 0.02 | 1.1 | 0.02 | 5 | 0.04 | 1 | 0.04 |
| Alumina trihydrate | 50 | 0.17 | 2.42 | 0.07 | 25 | 0.19 | 2.42 | 0.08 |
| 3M-K46 | 70 | 0.24 | 0.46 | 0.53 | 0 | 0.00 | 0.46 | 0.00 |
| pigment thickener | 1.4 | 0.00 | 1 | 0.00 | 1.4 | 0.01 | 1 | 0.01 |
| SMC glass | 60 | 0.21 | 2.6 | 0.08 | 0 | 0.00 | 2.6 | 0.00 |
| sum | 287.2 | 1.00 | avg ρ | 1.03 | 132.2 | 100.00 | avg ρ | 1.40 |

The glass bubbles shown in the instant example formulation are K46 grade (available from 3M) having isotactic crush strength of 6,000 psi.

The mechanical properties of the sandwich laminates may vary from the thickness of the core layer and each skin layer, and the SMC co-molding process.

The crush strength of the 3M K46 glass bubbles might be large enough for regular processing conditions; therefore, the co-molding process may be performed at times of less than 3 minutes with enough vacuum time for pre-heating.

### Example 2B. Medium Density Composite Formulation

An exemplary composite system in accordance with certain aspects of the present disclosure is provided in the instant example. The SMC used in the core layer of the instant example, also referred to as Alluralite™, can be used to make various composites like automotive panels. A composite system with a first skin layer and a second skin layer comprising glass fiber QISO prepreg, and a core layer with a density of 1.3 g/cm³ is provided in Table 2B. An unsaturated polyester (UP) resin is used in each layer.

TABLE 2B
QISO/SMC (core density~1.3)/QISO.

| | Core Layer (medium density) | | | | Skin Layer (QISO prepreg) | | | |
|---|---|---|---|---|---|---|---|---|
| Component | PHR | wf | ρ | wf/ρ | PHR | wf | ρ | wf/ρ |
| UP Resin mixture | 100 | 0.364 | 1.22 | 0.298 | 100 | 0.308 | 1.22 | 0.252 |
| Wetting agent | 1 | 0.004 | 1 | 0.004 | 1 | 0.003 | 1 | 0.003 |
| Initiator | 1 | 0.004 | 1 | 0.004 | 1 | 0.003 | 1 | 0.003 |
| Internal release | 5 | 0.018 | 1.1 | 0.017 | 5 | 0.015 | 1.1 | 0.014 |
| agent | | | | | | | | |
| Filler | 25 | 0.091 | 2.4 | 0.038 | 25 | 0.077 | 2.4 | 0.032 |
| Glass Bubble, 3M | 30 | 0.109 | 0.46 | 0.237 | | | | |
| Pigment thickener | 3 | 0.011 | 1 | 0.011 | 3 | 0.009 | 1 | 0.009 |
| SMC glass | 110 | 0.4 | 2.6 | 0.154 | | | | |
| Glass braid fabric | | | | | 190 | 0.585 | 2.6 | 0.225 |
| Sum | 275 | 1 | Average | 1.313 | 325 | 1.000 | Average | 1.857 |
| | | | S.G. | | | | S.G. | |

Panels were constructed using the two materials (core layer and skin layers) and the thickness was based on the dimensions after curing as follows:

Thin core sandwich: 0.7 mm QISO/6.15 mm core/0.7 mm QISO (total specific gravity (S.G.)=1.4)

Thick core sandwich panel: 0.7 mm QISO/8.6 mm core/0.7 mm QISO (total specific gravity (S.G.)=1.38)

The mechanical properties of the sandwich laminates may vary from the thickness of the core layer and each skin layer, and the SMC co-molding process.

The glass bubbles shown in the instant example formulation are iM16K grade (available from 3M) having isotactic crush strength of 16,000 psi.

The crush strength of the iM16K glass bubbles might be large enough for regular processing conditions; therefore, the co-molding process may be performed at times of less than 3 minutes with enough vacuum time for pre-heating.

### Example 3A. Low Density Composite Formulation

An exemplary composite system in accordance with certain aspects of the present disclosure is provided in the instant example. Such composites may be used in UAV (Un-manned aerial vehicles), high speed (HS) train panels. A composite system with a first skin layer and a second skin layer comprising glass fiber QISO prepreg, and a core layer with a density of 0.61 g/cm³ (about 0.6 g/cm³) is provided in Table 3A. An unsaturated polyester (UP) resin is used in each layer.

TABLE 3A
QISO/low density SMC (density~0.6)/QISO.

| | Core density ~0.6 | | | | | | | |
|---|---|---|---|---|---|---|---|---|
| | Core Layer | | | | Skin Layer (QISO prepreg) | | | |
| Formulation | PHR | wf | ρ | wf/ρ | PHR | wf | ρ | wf/ρ |
| UP Resin mixture | 100 | 0.38 | 1.3 | 0.29 | 100 | 0.76 | 1.3 | 0.58 |
| Wetting Agent | 0.4 | 0.00 | 1 | 0.00 | 0.4 | 0.00 | 1 | 0.00 |
| Initiator | 0.3 | 0.00 | 1 | 0.00 | 0.3 | 0.00 | 1 | 0.00 |
| Fine Zinc stearate | 5 | 0.02 | 1.1 | 0.02 | 5 | 0.04 | 1 | 0.04 |
| Alumina trihydrate | 25 | 0.10 | 2.42 | 0.04 | 25 | 0.19 | 2.42 | 0.08 |
| 3M-K25 | 80 | 0.31 | 0.25 | 1.22 | | | | |
| pigment thickener | 1.4 | 0.01 | 1 | 0.01 | 1.4 | 0.01 | 1 | 0.01 |
| SMC glass | 50 | 0.19 | 2.6 | 0.07 | | | | |
| sum | 262.1 | 1.00 | avg ρ | 0.61 | 132.1 | 1.00 | avg ρ | 1.40 |

The glass bubbles shown in the instant example formulation are K25 grade (available from 3M) having isotactic crush strength of 750 psi. The crush strength of the 3M K25 glass bubbles might take longer than 5 minutes and lower speed pressing to minimize crushing the glass bubbles in the sandwich structure with enough vacuum time for pre-heating. The thicker core layer may require a longer time to preheat and a lower speed of pressing. The fiber of the skin layer is not limited to glass fiber; and other fibers such as aramid fiber or carbon fiber may be used according to the particular application.

### Example 3B. Low Density Composite Formulation

An exemplary composite system in accordance with certain aspects of the present disclosure is provided in the instant example. Such composites may be used in a variety of applications like lightweight automotive parts to UAV (un-manned aerial vehicles) and high speed (HS) train panels. A composite system with a first skin layer and a second skin layer comprising glass fiber QISO prepreg, and a core layer with a density of 0.95 g/cm³ is provided in Table 3B. An unsaturated polyester (UP) resin is used in each layer.

TABLE 3B
QISO/low density SMC (core density~0.95)/QISO.

| | Core Layer (low density) | | | | Skin Layer (QISO prepreg) | | | |
|---|---|---|---|---|---|---|---|---|
| | PHR | wf | ρ | wf/ρ | PHR | wf | ρ | wf/ρ |
| UP Resin mixture | 100 | 0.48 | 1.22 | 0.390 | 100 | 0.308 | 1.22 | 0.252 |
| wetting agent | 1 | 0.00 | 1 | 0.005 | 1 | 0.003 | 1 | 0.003 |
| Initiator | 1 | 0.00 | 1 | 0.005 | 1 | 0.003 | 1 | 0.003 |
| Fine Zinc stearate | 5 | 0.02 | 1.1 | 0.022 | 5 | 0.015 | 1.1 | 0.014 |
| Filler | 25 | 0.12 | 2.4 | 0.050 | 25 | 0.077 | 2.4 | 0.032 |
| Glass Bubble, 3M | 50 | 0.24 | 0.46 | 0.518 | | | | |
| pigment thickener | 3 | 0.01 | 1 | 0.014 | 3 | 0.009 | 1 | 0.009 |
| SMC glass | 25 | 0.12 | 2.6 | 0.046 | | | | |
| Glass braid fabric | | | | | 190 | 0.585 | 2.6 | 0.225 |
| sum | 210 | 1.00 | average | 0.954 | 325 | 1.000 | average | 1.857 |
| | | | S.G. | | | | S.G. | |

The glass bubbles shown in the instant example formulation are iM16K, the same one used in Alluralite™, for comparison purposes. A lower density core could also be obtained by using lower density glass bubble products like K25 grade (available from 3M) having isotactic crush strength of 750 psi. The crush strength of the K25 glass bubbles might take longer than 5 minutes and lower speed pressing to minimize crushing the glass bubbles in the sandwich structure with enough vacuum time for pre-heating. The thicker core layer may require a longer time to preheat and a lower speed of pressing. The fiber of the skin layer is not limited to glass fiber; and other fibers such as aramid fiber or carbon fiber may be used according to the particular application.

### Example 4. Mechanical Properties of Sandwich Composites

The instant example provides mechanical properties of four panels prepared. An SMC only panel was constructed using the formulation provided in Example 1A, Table 1A. A thin medium-density core sandwich panel and a thick medium-density core sandwich panel were constructed using the formulation provided in Example 2B, Table 2B. A low-density core sandwich panel was constructed using the formulation provided in Example 3B, Table 3B. The results, including flexural strength, flexural modulus and deflection, are shown in Tables 4A and 4B.

TABLE 4A
Flexural properties of panels

| | | | | Specific | | Specific |
|---|---|---|---|---|---|---|
| | Thickness | | Flexural | flexural | Flexural | flexural |
| Panel structure | (mm), | | strength, | strength, | modulus, | modulus, |
| (12″ × 12″) | Total (layers) | S.G. | MPa | MPa | GPa | GPa |
| Ex. 1A | 6.3 | 1.68 | 253.99 | 151.18 | 12.34 | 7.35 |
| (SMC only) | (6.3) | | | | | |
| Ex. 2B | 7.55 | 1.4 | 271.58 | 193.98 | 14.02 | 10.02 |
| (Thin Sandwich) | (0.7 + 6.15 + 0.7) | | | | | |
| Ex. 2B | 10 | 1.38 | 231.12 | 167.48 | 12.08 | 8.76 |
| (Thick Sandwich) | (0.7 + 8.6 + 0.7) | | | | | |
| Ex. 3B | 10 | 1.077 | 191.83 | 178.12 | 10.09 | 9.36 |
| (Low density | (0.7 + 8.6 + 0.7) | | | | | |
| Sandwich) | | | | | | |

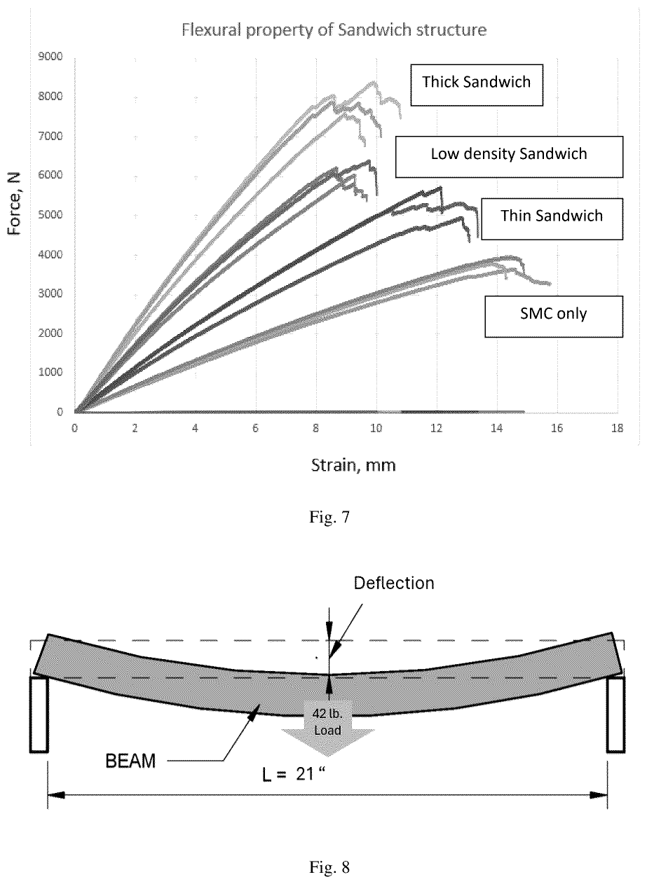

The flexural properties were measured by a 3-point loading method of ASTM C393 (Standard Test Method for Core Shear Properties of Sandwich Constructions by Beam Flexure). The raw data as force (N) vs. strain (mm) is shown in FIG. 7. The flexural properties (flexural strength and modulus) were calculated from the raw data, and the specific properties provided in Table 4A were calculated using the relationship of “flexural property/specific gravity”. In the raw data, thin one shows the lower flexural force but specific properties considering thickness in equation shows best specific flexural properties in strength and modulus. In comparison to the single layer SMC composite (Ex. 1A), all sandwich panels show the better flexural properties, due to lighter weight.

TABLE 4B
Deflection test results

| | Thickness | | | | |
|---|---|---|---|---|---|
| Panel structure | (mm), | weight, | | | |
| (12 “×24”) | Total (layers) | g | S.G. | Deflection | |
| Ex. 1A | 6.3 | 1031 | 1.68 | ~5 | mm |
| (SMC only) | (6.3) | | | | |
| Ex. 2B | 7.55 | 996 | 1.4 | ~2 | mm |
| (Thin Sandwich) | (0.7 + 6.15 + 0.7) | | | | |
| Ex. 2B | 10 | 1268 | 1.38 | <0.1 | mm |
| (Thick Sandwich) | (0.7 + 8.6 + 0.7) | | | | |
| Ex. 3B | 10 | 993 | 1.077 | <0.1 | mm |
| (Low density | (0.7 + 8.6 + 0.7) | | | | |
| Sandwich) | | | | | |

The sandwich panel stiffness was measured using the deflection test shown in FIG. 8. The testing conditions included a center part deflection measurement under 42 1b. load with 21″ span. The results of the deflection test can show a difference of stiffness between tested composite panels.

The sandwich structures showed improved stiffness in comparison to the SMC only composite. In particular, sandwich panels including a thick core and low-density core show excellent stiffness (error range deflection in the test).

Because there are various combinations of skin and core layers with dimensional freedom in the composites according to the present disclosure, it can be difficult to provide standard testing conditions to measure stiffness. For example, alternative testing conditions can be found, such as “Howard G. Allen, Analysis and design of structural sandwich panels” and “Hexcel HexWeb honeycomb sandwich design technology.” The testing conditions in the instant example of a 42 lb. load with about 21″ span was determined through trial and error. Alternative testing conditions may provide differences in deflection test results between composites panels.

### Example 5. Carbon Skin and Ultra Low Density Core Composite Formulation

An exemplary composite system in accordance with certain aspects of the present disclosure is provided in the instant example. Such ultra-low density composites may be used in UAM (urban air mobility). A composite system with a first skin layer and a second skin layer comprising carbon fiber prepreg, and a core layer with a density of 0.30 g/cm³ is provided in Table 5. An unsaturated polyester (UP) resin is used in each layer.

TABLE 5
Carbon Anisotropic Fabric/Ultra low-density
SMC (density ~0.3)/Carbon Anisotropic Fabric.

| | Core density ~0.3 | | | | | | | |
|---|---|---|---|---|---|---|---|---|
| | Core Layer | | | | Skin Layer (Carbon prepreg) | | | |
| Formulation | PHR | wf | ρ | wf/ρ | PHR | wf | ρ | wf/ρ |
| UP Resin mixture | 100 | 0.34 | 1.3 | 0.26 | 100 | 0.76 | 1.3 | 0.58 |
| Wetting Agent | 0.4 | 0.00 | 1 | 0.00 | 0.4 | 0.00 | 1 | 0.00 |
| Initiator | 0.2 | 0.00 | 1 | 0.00 | 0.2 | 0.00 | 1 | 0.00 |
| Fine Zinc stearate | 5 | 0.02 | 1.1 | 0.02 | 5 | 0.04 | 1 | 0.04 |
| Alumina trihydrate | 25 | 0.09 | 2.42 | 0.04 | 25 | 0.19 | 2.42 | 0.08 |
| 3M-K11 | 110 | 0.38 | 0.13 | 2.90 | | | | |
| pigment thickener | 1.4 | 0.00 | 1 | 0.00 | 1.4 | 0.01 | 1 | 0.01 |
| SMC glass | 50 | 0.17 | 2.6 | 0.07 | | | | |
| sum | 292 | 1.00 | avg ρ | 0.30 | 132 | 1.00 | avg ρ | 1.40 |

The glass bubbles shown in the instant example formulation are K11 grade (available from 3M) having isotactic crush strength of about 250 psi. Because the isotactic crush strength is low, it might take increased cycle time (pressing and curing) of longer than hours. However, the exemplary composite may still have more advantage over a comparative honeycomb sandwich manufacturing process, especially machined core sandwich composites. In case of a comparative honeycomb, the manufacturing process is time-consuming and includes printing, sheeting, laying-up, bonding, expanding, dipping, curing, cutting. The core layer is used to sandwich the structure by machining and bonding with skin layer. In another comparative example, a foam core could be less time-consuming, but still needs to be machined and bonded (using adhesive) with skin layers.

### Example 6. Aerospace Application

The standard molding with UP formulations are provided in the preceding examples. The applications using composite systems in accordance with certain aspects of the present disclosure may be demonstrated with applicable parts, composed materials, and recommended co-molding guides in the instant example and following examples.

An exemplary application of a composite system in accordance with certain aspects of the present disclosure is provided in the instant example. The following application using a composite system is shown in Table 6. Carbon fiber QISO/epoxy skin layers and a FR class2 epoxy ultra-low density (0.3 g/cm³) core layer may be used for a flame retarding interior panel for UAV or UAM. An epoxy resin is used in each layer. The phosphorus flame retarding agent (available from Clariant or Thor) instead of aluminum trihydrate (ATH) is chosen to lower the density. The internal mold release agent is used for the adhesive epoxy resin demolding. Epoxy resin and latent type curing agent may provide a reaction rate (cycle time) over one hour at around 150° C., which may include slow pressing without the crushing of the hollow glass bubbles (HGBs). Without being bound by any theory, a more reliable HGB (lower density with higher isostatic crushing strength) could be developed to further lower the density of the molded parts.

TABLE 6
Composite sandwich system for aerospace application.

| | Aerospace | | | | | | | |
|---|---|---|---|---|---|---|---|---|
| | FR Class 2 Ultra-low density | | | | | | | |
| | Core Layer | | | | Skin Layer (Carbon prepreg) | | | |
| Formulation | PHR | wf | ρ | wf/ρ | PHR | wf | ρ | wf/ρ |
| Epoxy Resin | 100 | 0.41 | 1.15 | 0.36 | 100 | 0.75 | 1.15 | 0.65 |
| Wetting Agent | 0.4 | 0.00 | 1 | 0.00 | 0.4 | 0.00 | 1 | 0.00 |
| Curing Agent | 10 | 0.04 | 1 | 0.04 | 10 | 0.07 | 1 | 0.07 |
| Mold Release Agent | 2 | 0.01 | 1.1 | 0.01 | 2 | 0.01 | 1.1 | 0.01 |
| Phosphorus | 20 | 0.08 | 1.9 | 0.04 | 20 | 0.15 | 1.9 | 0.08 |
| 3M-K11 | 90 | 0.37 | 0.13 | 2.84 | | | | |
| Pigment Thickener | 1.4 | 0.01 | 1 | 0.01 | 1.4 | 0.01 | 1 | 0.01 |
| SMC glass fiber | 20 | 0.08 | 2.6 | 0.03 | | | | |
| Sum | 243.8 | 1.00 | avg ρ | 0.30 | 133.8 | 1.00 | avg ρ | 1.20 |

The sandwich laminates are made in a co-molding process without adhesive panel bonding. Thus, floor or wall panels prepared from the composite system of the instant example may be used as a low-cost sandwich material having strong interlaminar shear strength.

### Example 7. Automotive Application

An exemplary application of a composite system in accordance with certain aspects of the present disclosure is provided in the instant example. The following application using a composite system is shown in Table 7. Glass fiber QISO/UP skin layers and a medium density (0.9 g/cm³) core layer may be used for a high stiffness panel in a truck pickup box or a battery enclosure. An unsaturated polyester (UP) resin is used in each layer. Slightly slow molding such as 150° C. for 5 minutes may allow greater survivability of the HGBs (iM 16k with 16,000 isostatic crush strength, available from 3M) during the pressing and demolding, which may save total processing time.

TABLE 7
Composite sandwich system for automotive application.

| | Automotive | | | | | | | |
|---|---|---|---|---|---|---|---|---|
| | Medium Density Core Layer | | | | Skin Layer (Glass prepreg) | | | |
| Formulation | PHR | wf | ρ | wf/ρ | PHR | wf | ρ | wf/ρ |
| UP Resin mixture | 100 | 0.48 | 1.3 | 0.37 | 100 | 0.79 | 1.3 | 0.61 |
| wetting agent | 0.4 | 0.00 | 1 | 0.00 | 0.4 | 0.00 | 1 | 0.00 |
| Initiator | 0.3 | 0.00 | 1 | 0.00 | 0.3 | 0.00 | 1 | 0.00 |
| Fine Zinc stearate | 5 | 0.02 | 1.1 | 0.02 | 5 | 0.04 | 1 | 0.04 |
| Alumina trihydrate | 20 | 0.10 | 2.42 | 0.04 | 20 | 0.16 | 2.42 | 0.07 |
| 3M-IM 16k | 60 | 0.29 | 0.46 | 0.63 | | | | |
| pigment thickener | 1.4 | 0.01 | 1 | 0.01 | 1.4 | 0.01 | 1 | 0.01 |
| SMC glass | 20 | 0.10 | 2.6 | 0.04 | | | | |
| sum | 207.1 | 1.00 | avg ρ | 0.90 | 127.1 | 1.00 | avg ρ | 1.38 |

### Example 8. Train Application

An exemplary application of a composite system in accordance with certain aspects of the present disclosure is provided in the instant example. The following application using a composite system is shown in Table 8. Glass fiber QISO/epoxy skin layers and a low density (0.6 g/cm³) core layer may be used for a high stiffness panel having enough thickness in a high-speed train interior floor and/or wall. An epoxy resin is used in each layer. Epoxy resin and latent type curing agent may provide a reaction rate over one hour at around 150° C., which may provide slow pressing without the crushing of HGBs.

TABLE 8
Composite sandwich system for train application.

| | Train | | | | | | | |
|---|---|---|---|---|---|---|---|---|
| | Low Density Core Layer | | | | Skin Layer (Glass prepreg) | | | |
| Formulation | PHR | wf | ρ | wf/ρ | PHR | wf | ρ | wf/ρ |
| Epoxy resin | 100 | 0.42 | 1.15 | 0.37 | 100 | 0.79 | 1.15 | 0.69 |
| wetting agent | 0.4 | 0.00 | 1 | 0.00 | 0.4 | 0.00 | 1 | 0.00 |
| Curing agent | 10 | 0.04 | 1 | 0.04 | 10 | 0.08 | 1 | 0.08 |
| Fine Zinc stearate | 5 | 0.02 | 1.1 | 0.02 | 5 | 0.04 | 1 | 0.04 |
| Alumina trihydrate | 10 | 0.04 | 2.42 | 0.02 | 10 | 0.08 | 2.42 | 0.03 |
| 3M-K25 | 70 | 0.30 | 0.25 | 1.18 | | | | |
| pigment thickener | 1.4 | 0.01 | 1 | 0.01 | 1.4 | 0.01 | 1 | 0.01 |
| SMC glass | 40 | 0.17 | 2.6 | 0.06 | | | | |
| sum | 236.8 | 1.00 | avg ρ | 0.59 | 126.8 | 1.00 | avg ρ | 1.18 |

1. A composite sandwich system comprising:
a first skin layer and a second skin layer, wherein each of the first skin layer and the second skin layer independently comprise a first formulation and a continuous fiber; and
a core layer extending between and interconnecting the first skin layer and the second skin layer, the core layer comprising a second formulation, a discontinuous fiber, and optionally a low-density component.

2. The composite sandwich system of claim 1, wherein the composite system is free of an adhesive.

3. The composite sandwich system of claim 2, wherein the first formulation comprises a first resin and the second formulation comprises a second resin.

4. The composite sandwich system of claim 3, wherein the first resin and the second resin are the same.

5. The composite sandwich system of claim 4, wherein each of the first resin and the second resin is a thermoset resin selected from the group consisting of unsaturated polyester, vinyl ester, epoxy, and any combination thereof.

6. The composite sandwich system of claim 5, wherein the continuous fiber is a glass fiber, carbon fiber, aramid fiber, or a basalt fiber.

7. The composite sandwich system of claim 6, wherein the discontinuous fiber is a glass fiber, carbon fiber, aramid fiber, or a basalt fiber.

8. The composite sandwich system of claim 7, wherein the discontinuous fiber is selected from the group consisting of AES glass, E glass, ECR glass, silica glass, S glass, R glass, M glass, C glass, D glass, AR glass, T glass, Q glass, and any combination thereof.

9. The composite sandwich system of claim 8, wherein the discontinuous fiber is a chopped fiber of about 0.5 inches to about 2 inches in length.

10. The composite sandwich system of claim 9, wherein the core layer comprises the low-density component, and the low-density component is selected from the group consisting of glass bubbles, organic microspheres, inorganic microspheres, expandable polymer microspheres, and any combination thereof.

11. The composite sandwich system of claim 10, wherein the low-density component is present in the core layer at about 10 wt % to about 60 wt %.

12. The composite sandwich system of claim 11, wherein the core layer has a density of about 1.5 g/cm³ or less.

13. The composite sandwich system of claim 4, wherein each of the first formulation and the second formulation independently comprises an additive selected from the group consisting of an initiator, a wetting agent, a release agent, a flame retarding agent, a filler, a pigment/thickener, and any combination thereof.

14. The composite sandwich system of claim 13, wherein each of the first formulation and the second formulation independently comprises an initiator, wherein the initiator is present in the first formulation, the second formulation, or the first formulation and the second formulation at a ratio of about 100:0.1 to about 100:2 resin to initiator.

15. The composite sandwich system of claim 13, wherein each of the first formulation and the second formulation independently comprises a release agent, wherein the release agent is present in the first formulation, the second formulation, or the first formulation and the second formulation at a ratio of about 100:1 to about 100:10 resin to release agent.

16. The composite sandwich system of claim 13, wherein each of the first formulation and the second formulation independently comprises a filler, wherein the filler is present in the first formulation, the second formulation, or the first formulation and the second formulation at a ratio of about 100:20 to about 100:80 resin to filler.

17. The composite sandwich system of claim 1, wherein the continuous fiber is impregnated with the first formulation.

18. A compression-molded product comprising a composite sandwich system according to claim 1.

19. A method of preparing a composite sandwich system according to claim 1, the method comprising a step of compression molding the first skin layer, the core layer, and the second skin layer.

20. The method of claim 19, wherein the compression molding comprises co-molding the first skin layer, the core layer, and second skin layer simultaneously.
